(19) United States
(12) Patent Application Publication
(10) Pub. No.: US 2009/0202310 A1
(43) Pub. Date: Aug. 13, 2009

(54) SUPPORT FOR UNDERGROUND MINING AND TUNNEL CONSTRUCTION

(75) Inventor: MANFRED KOPPERS, Duisburg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Bochumer Eisenhutte Heintzmann GmbH & Co. KG, Bochum (DE)

(21) Appl. No.: 12/428,913

(22) Filed: Apr. 23, 2009

Related U.S. Application Data
(63) Continuation-in-part of application No. PCT/DE2008/000375, filed on Mar. 4, 2008.

(30) Foreign Application Priority Data
Nov. 27, 2007 (DE) 20 2007 016 572.2

(51) Int. Cl. E21D 15/44; B23P 11/00; E21D 23/16

(52) U.S. Cl. 405/290; 29/428

(57) ABSTRACT

A hydraulic support for underground mining and tunnel construction includes an outer tube to form an upper prop and an inner tube which forms a lower prop and is received in the outer tube to define a pressure chamber. A footpiece is secured to a lower end of the inner tube. Provided on the upper end of the inner tube is a piston which is sealingly guided along the outer tube as pressure fluid is admitted into the upper prop. Disposed inside the lower prop at a location below the piston is a valve block for introducing pressure fluid into the pressure chamber, with a pressure tube connecting the valve block with the piston to thereby define a constant distance of the valve block to the footpiece.

### CROSS-REFERENCES TO RELATED APPLICATIONS

This application is a continuation-in-part of prior filed copending PCT International Application No. PCT/DE2008/000375, filed Mar. 4, 2008, which designated the United States and on which priority is claimed under 35 U.S.C. §120 and which claims the priority of German Patent Application, Serial No. 20 2007 016 572.2, filed Nov. 27, 2007, pursuant to 35 U.S.C. 119(a)-(d), the contents of which are incorporated herein by reference in their entirety as if fully set forth herein.

### BACKGROUND OF THE INVENTION

The present invention relates to a hydraulic support for underground mining and tunnel construction.

The following discussion of related art is provided to assist the reader in understanding the advantages of the invention, and is not to be construed as an admission that this related art is prior art to this invention.

Austrian Pat. No. 310698 describes a support having an upper prop, which is formed by an outer tube, and a lower prop, which is formed by an inner tube that is slidingly guided in the upper prop and has an end inside the outer tube for securement of a piston. The piston has a seal to seal a pressure chamber above the piston against the ambient atmosphere. A welded-in plate forms the upper end of the pressure chamber and has a top side outside the pressure chamber for receiving a valve block in which a setting and release valve and a pressure relief valve are snugly fitted. As a result, access to the valve block is difficult, in particular when the support is of substantial size, so that the need for a platform or ladder becomes necessary for operation.

It would therefore be desirable and advantageous to provide an improved support for underground mining and tunnel construction to obviate prior art shortcomings.

### SUMMARY OF THE INVENTION

According to one aspect of the present invention, a hydraulic support for underground mining and tunnel construction includes an outer tube to form an upper prop, an inner tube forming a lower prop and having an upper end, with the inner tube received in the outer tube and defining a pressure chamber, a footpiece secured to a lower end of the inner tube, a piston provided on the upper end of the inner tube and sealingly guided along the outer tube as pressure fluid is admitted into the upper prop, a valve block disposed inside the lower prop at a location below the piston for introducing pressure fluid into the pressure chamber, and a pressure tube connecting the valve assembly with the piston to thereby define a constant distance of the valve assembly to the footpiece.

The present invention resolves prior art problems by disposing the piston in close proximity underneath a head plate of the support and resting atop the upper end of the inner tube. As a result, regardless of the extended length of the support, the operating elements remain at a constant height above the footpiece and thus are reachable at any time. At the same time, the footwall is not contaminated by dirt.

According to another feature of the present invention, a combined setting and release valve and a pressure relief valve can be threadably engaged in bores of the valve block. Suitably, the inner tube has a wall formed with a bore for threaded engagement of the combined setting and release valve from outside into the valve block, with the setting and release valve having a diametrical constriction to define a shoulder so as to fix the setting and release valve in place. The extension of the setting and release valve through the wall of the inner tube can be selected as close as possible to the bottom edge of the outer tube, when the support is fully retracted so that there is sufficient distance from the footwall. As a result of this construction, the setting and release valve remains at a constant level above the footpiece without the need for an auxiliary device and independent on the extended length of the support.

A support according to the present invention can be operated in an open system. Pressure fluid is supplied from outside via a pressure conduit and escapes into the atmosphere via a pressure relief valve, when the support is pushed up against the rock formation. The support can be separated from the top wall by opening the check valve. As a result, pressure fluid escapes to the atmosphere via the setting and release valve.

According to another aspect of the present invention, a method of making a support for underground mining and tunnel construction includes the steps of attaching one end of a pressure tube to a confronting side of a valve block mounted to an inner tube at a constant distance to a footpiece, placing a piston upon an upper end of the inner tube and sealing the piston against an outer tube disposed in surrounding relationship to the inner tube, guiding the pressure tube through a bore in the piston until another end of the pressure tube projects beyond the piston to define a projecting part, welding the pressure tube to the piston in an area of the projecting part, and separating the projecting part from the pressure tube.

According to another feature of the present invention, the projecting part may be separated to provide an even configuration between a top surface of the piston and an upper end of the pressure tube.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a vertical longitudinal section of one embodiment of a support according to the present invention at almost fully retracted position;

FIG. 2 is a sectional view, on an enlarged scale, of a setting and release valve with attached pressure conduit;

FIG. 3 is a sectional view of the setting and release valve with inserted relief bolt; and

FIG. 4 is a vertical longitudinal section of another embodiment of a support according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

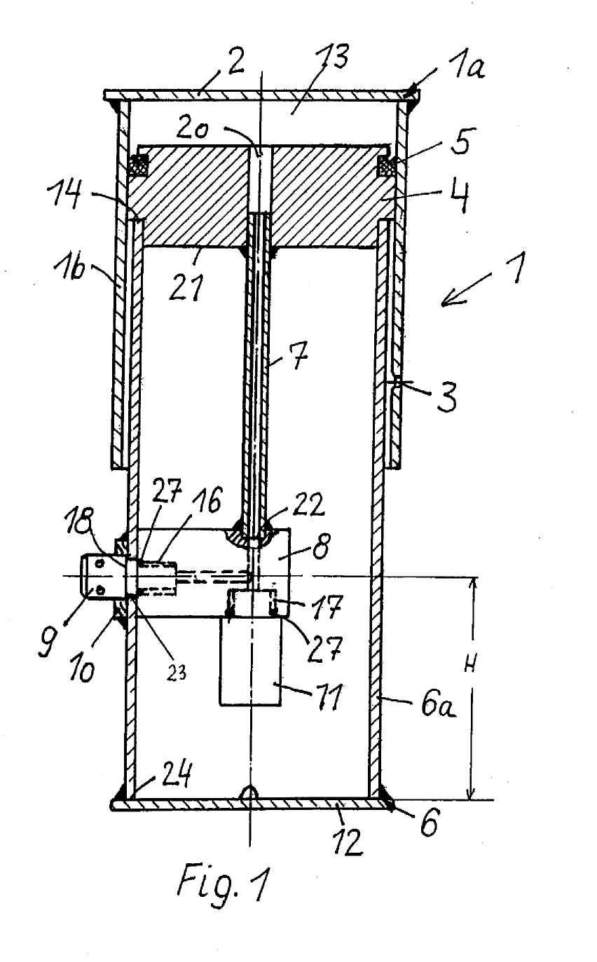

Turning now to the drawing, and in particular to FIG. 1, there is shown a vertical longitudinal section of one embodiment of a support according to the present invention, generally designated by reference numeral 1. The support 1 includes a head plate 2 to which an upper end of an outer tube 1b, defining an upper prop 1a, is welded in a pressure-sealed manner. A piston 4 is received in the outer tube 1b and rests upon an upper end 14 of an inner tube 6a which projects into the outer tube 1b. The piston 4 is sealed against the outer tube 1b by a seal 5 and defines a pressure chamber 13.

The piston 4 is formed with a central bore 20 into which a pressure tube 7 projects. The pressure tube 7 is welded to a pressure-chamber-distal bottom side 21 of the piston 4 in a pressure-sealed manner and has a piston-distal end 22 for welded attachment of a valve block 8 in a pressure-sealed manner. A pressure relief valve 11 is threadably engaged with a thread 17 of the valve block 8 in a pressure-sealed manner.

The inner tube 6a defines a lower prop 6 and has a piston-distal end 24 which is welded to a footpiece 12 in a non-pressure-sealed manner. The inner tube 6a is provided with an opening 23 for passage of a setting and release valve 9 which has a thread 16 for threaded engagement into the valve block 8 in a pressure-sealed manner. The opening 23 is hereby reinforced by an apertured plate 10. The setting and release valve 9 is provided with a diametrical constriction to define a shoulder 18 for abutment against the inner tube 6a so as to be prevented for inadvertently being pushed into the inner prop 6. The valve block 8 has a size sufficient to prohibit a withdrawal through the opening 23. As a result, the valve block 8 is fixed in place at a constant height H above the footpiece 12, and the piston 4 is secured against detachment from the upper end 14 of the inner tube 6a. As the lower end 24 of the inner tube 6a is not welded to the footpiece 12 in a pressure-sealed manner, pressure fluid is discharged from the pressure relief valve 14, when the maximal load-bearing capacity of the support 1 has been reached, and is able to drain onto the footwall.

The outer tube 1b of the upper prop 1a is further provided with a bore 3 through which pressure fluid is able to escape, when the bore 3 is passed by the seal 5 of the piston 4 so that the upper prop 1a of the support 1 can no longer move out in relation to the lower prop 6.

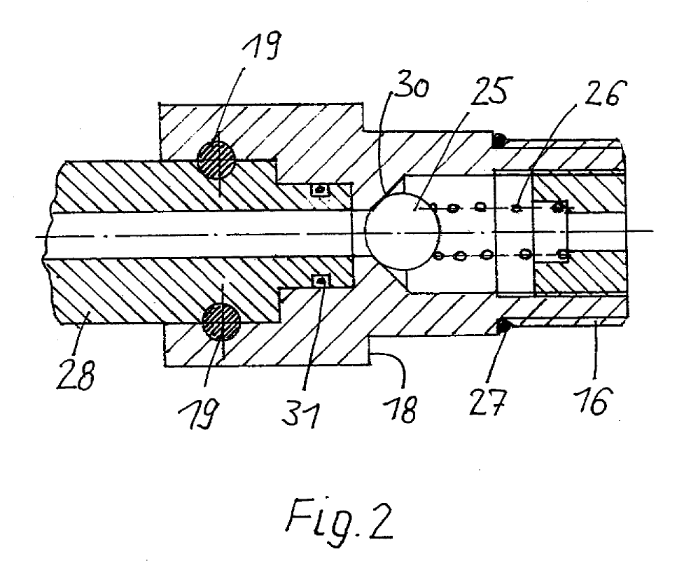

FIG. 2 is a sectional view, on an enlarged scale, of the setting and release valve 9 with attached pressure conduit 28 which is held in place by safety pins 19.

When an unillustrated shut-off device, e.g. a conventional ball valve, disposed in the pressure conduit 28 is opened, the support 1 is operated in setting mode by conducting pressure fluid via a check valve 25, the valve block 8 and the pressure tube 7 into the pressure chamber 13 so that the support 1 moves out until impacting a resistance, e.g. the top wall, and thus clamped. Detaching the pressure conduit 28 from the setting and release valve 9 causes pressure in the pressure chamber 13 to press the check valve 25 against valve seat 30 so that escape of pressure fluid is prevented.

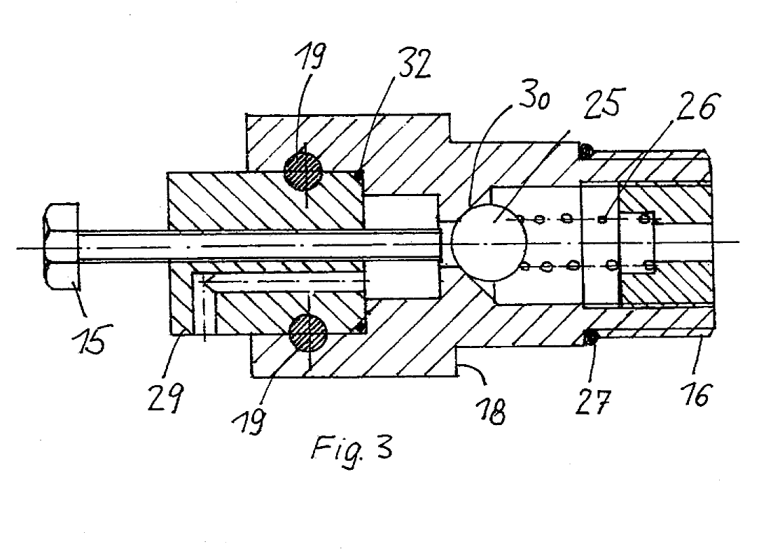

FIG. 3 is a sectional view of the setting and release valve 9 with inserted relief bolt 15 by which the recovery or release mode is initiated. As the relief bolt 15 is inserted, the check valve 25 is moved away from the valve seat 30 to allow pressure fluid to escape the pressure chamber 13.

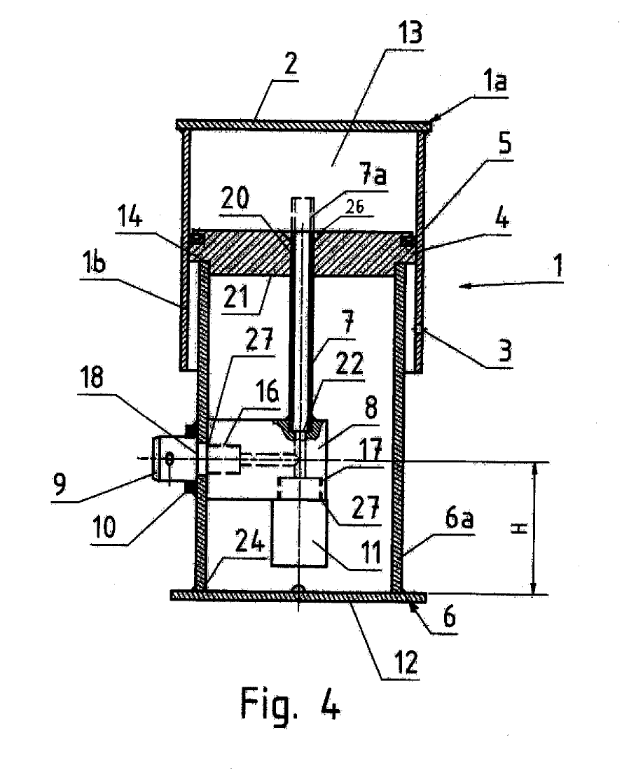

Referring now to FIG. 4, there is shown a vertical longitudinal section of another embodiment of a support 1 according to the present invention. Parts corresponding with those in FIG. 1 are denoted by identical reference numerals and not explained again. The description below will center on the differences between the embodiments. In this embodiment, provision is made for a welded attachment in a pressure-sealed manner of the pressure tube 7 to a top surface of the piston 4. The piston 4 bears upon the upper end 14 of the inner tube 6a, with the pressure tube 7 extending through the central bore 20 in the piston 4 beyond the top surface of the piston 4 to define a projecting part 7a.

The welded attachment of the pressure tube 7 to the piston 4 is realized as follows: The pressure tube 7 is pushed through the bore 20 until part 7a of the pressure tube 7 projects beyond the top surface of the piston 4. The pressure tube 7 is then welded to the piston 4, suitably in a welding space 26. After the pressure tube 7 has been welded to the piston 4, the projecting part 7a can be separated through cutting or another suitable process, thereby attaining a flush configuration between the upper end of the pressure tube 7 and the top surface of the piston 4. Implementation of the welded attachment in this manner is simple.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A hydraulic support for underground mining and tunnel construction, comprising:
an outer tube to form an upper prop;
an inner tube forming a lower prop and having an upper end, said inner tube received in the outer tube and defining a pressure chamber;
a footpiece secured to a lower end of the inner tube;
a piston provided on the upper end of the inner tube and sealingly guided along the outer tube as pressure fluid is admitted into the upper prop;
a valve block disposed inside the lower prop at a location below the piston for introducing pressure fluid into the pressure chamber; and
a pressure tube connecting the valve block with the piston to thereby define a constant distance of the valve block to the footpiece.

2. The support of claim 1, further comprising a combined setting and release valve and a pressure relief valve which are threadably engaged in bores of the valve block.

3. The support of claim 2, wherein the inner tube has a wall formed with a bore for threaded engagement of the combined setting and release valve into the valve block, said combined setting and release valve having a shoulder to fix the setting and release valve in place.

4. The support of claim 2, further comprising a relief bolt for temporary insertion in the setting and release valve for release of the support.

5. The support of claim 1, further comprising a seal received in the piston for sealing the piston against the outer tube, said outer tube provided with a bore for escape of fluid to the outside, when the bore is passed by the seal so as to prevent the upper prop for further being moved out.

6. The support of claim 1, wherein the pressure tube is welded to a bottom side of the piston.

7. The support of claim 1, wherein the pressure tube is welded to a topside of the piston.

8. The support of claim 1, wherein the pressure tube is received centrally within the piston.

9. The support of claim 1, wherein the valve block is welded to the pressure tube.

10. A method of making a support for underground mining and tunnel construction, comprising the steps of:
attaching one end of a pressure tube to a confronting side of a valve block mounted to an inner tube at a constant distance to a footpiece;
placing a piston upon an upper end of the inner tube and sealing the piston against an outer tube disposed in surrounding relationship to the inner tube;
guiding the pressure tube through a bore in the piston until another end of the pressure tube projects beyond the piston to define a projecting part;
welding the pressure tube to the piston in an area of the projecting part; and
separating the projecting part from the pressure tube.

11. The method of claim 10, wherein the projecting part is separated to provide an even configuration between a top surface of the piston and an upper end of the pressure tube.

12. The method of claim 10, wherein the projecting part is separated by a cutting operation.

13. The method of claim 10, further comprising the step of connecting a combined setting and release valve from outside through a bore in the inner tube with the valve block.
